(19) United States
(12) Patent Application Publication
(10) Pub. No.: US 2011/0022516 A1
(43) Pub. Date: Jan. 27, 2011

(54) Multiple Payments at One Click

(76) Inventors: Hong Gao, McKinney, TX (US); Jie Tan, McKinney, TX (US)

Correspondence Address: Jie Tan, 10212 Brenden Dr, McKinney, TX, 75070, US

(21) Appl. No.: 12/509,456

(22) Filed: Jul. 25, 2009

(51) Int. Cl. G06Q 20/00; G06F 15/16; G06F 3/048

(52) U.S. Cl. 705/40; 709/206; 715/764

(57) ABSTRACT

A 1-click method for executing an expedited payment package of paying multiple bills right away through Internet. A user logs into an online bill pay account in a server system from a client system, and receives a web document specifying all bills including a 1-click-pay button. The user prepares a payment package of multiple bills, including a plurality of the identifications of the receiver, bill details, schedule definitions, and delivery details. After selection of 1-click-pay button performed by the user, the client system sends the payment package and a request to execute. Server system collectively processes bill payments the same day or right away according to the payment package and its settings but overriding the previously defined schedule for individual bill.

### BACKGROUND

The present application relates to one click execution of multiple actions, more particularly, to a method for collectively completing multiple bill payments with one mouse click online over the Internet.

Note that the points discussed below may reflect the hindsight gained from the disclosed inventions, and are not necessarily admitted to be prior art.

The prevailing online bill pay services are usually associated with a funded account to let users or payers make a scheduled payment as to who, when and how much to pay. Users need to sign up for an online bill pay service through the webpage of a financial institution.

The bill pay services need to have payer-specific information that may include the payer's name, the funding account number and balance. The users need to type in receiver-specific information that may include the receiver's name, the amount, delivery date, and address. Users decide what dates and frequencies a payment gets made, either one time, or weekly, or monthly, or any other time schedule such as every 10 days. Online bill pay transaction was usually sent on the previously scheduled dates given by the user. The payment usually arrives in several business days.

A server system may provide an online catalog with the bills previously stored. The user, who is a login payer, may browse through the catalog and select a bill to be paid. The server system then typically confirms the paying instruction by sending a webpage to the client system and commits the scheduled bill payment.

Selection of a bill to pay is generally based on the “Individual Payment” model. A bill is in a to-be paid status when payer selects it. When payer selection is done, all selected bills will be executed individually, according to each specific scheduled delivery date, by the server system.

This individual payment model is intuitive and flexible, but it requires many interactions by the payer. For example, the payer selects a bill from the catalog, and then indicates the selection is complete. Next, a confirmation webpage is presented to the payer. That webpage may be filled with information which was provided by the payer. The information is then validated by the server, and the payment process is completed.

In such an individual payment model, if a payer is paying several bills, there is a big overhead of confirming the various steps of the payment process, viewing, and updating the payer-specific payment information. This overhead makes the payment of multiple bills burdensome. Also, each time a payment is made, sensitive information is transmitted over the Internet, and it may be intercepted, thus cause a security concern. It is desirable to minimize the sensitive information transmitted when making bill payments.

Periodically, a user needs to log into his account multiple times for multiple bill payments, and he may need to make many changes in order to pay all the bills if he wishes to pay off all those bills today.

### SUMMARY

The present application discloses new approaches for making a group of online bill payments right away with 1-click from an Internet browser. It is a method for single-action bill pay in a client-server environment. The single-action bill paying system of the present application reduces the number of payer interactions needed to pay bills, and reduces the amount of sensitive information that is transmitted between client and server systems.

In one embodiment, a user logs into an online bill pay account in a server system from a client system, and obtains from the server system a client identifier and a web document describing all his bills including a 1-click-pay button. The user prepares a payment package of multiple bills, including a plurality of the identifications of the receiver, bill details, schedule definitions, and delivery details. After selection of 1-click-pay button performed by the user, the client system sends to the server system the payment package and a request to execute it. The server system processes bill payments in the same day or immediately in accordance to the payment package setting, overriding the previously defined schedule for each bill.

In one embodiment, the client system is usually a web browser. It receives an identifier from the server system that identifies a logged in user. It displays information of a bill catalog and an indication of a single action (such as clicking a mouse button) that a payer performs to complete the preparation. In response to the performed action, it sends to the server its identifier and a request to pay the selected bills. It allows the user to make changes to each individual bill. It also allows user to cancel the whole bill pay process even after selection of the 1-click-pay button. It has an option for users to pay bill in other selected ways, for example, to pay each bill one by one.

In one embodiment, the server system stores the account information for multiple users. It provides a user identifier to a client system when a user logs in. It combines the account information in association with the identifier of a client system. When a user logs in, the server system provides an online catalog describing the bills to the requesting user. When the server system receives a request to pay, it retrieves the payer's account information to execute the grouped bill payments; it then generates the confirmation webpage and sends it to the client system.

In one embodiment, the expedited payment package groups multiple bills together to be paid immediately or soon. It makes paying multiple bills very user friendly. Similar to a conventional individual bill payment, a payer is allowed to cancel the package within a specific time period after it has been sent to the server. To ensure selected payments are properly executed, accurate payment information will need to be set first. The required information may include the name of a payee, the delivery address and amount, schedule to initiate immediately or before the due date and funds available in the accounts to cover the total amount of the payments.

The 1-click setting is stored in the server system for a validated payer. It instructs the server rules on executing grouped payments at the same time. The 1-click group payment feature may be set as the default or may be disabled upon the user's request. The default setting may be to execute payments today, or it may be set for another day. It may also allow user to choose if a confirmation webpage is needed after submission or execution of the payment package.

The disclosed innovations, in various embodiments, provide one or more of at least the following advantages. However, not all of these advantages result from every one of the innovations disclosed, and this list of advantages does not limit the various claimed inventions.
Reduces payer interactions for multiple payments;
Reduces the number of times of sensitive information being transmitted over the internet.
Increased efficiency, promptness, and simplified payment processes.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 is a block diagram illustrating an embodiment of the present invention, viewing from the client system side.

FIG. 2 is a complete webpage in which single-action payment package is compiled and enabled, viewing from a client system side.

FIG. 3 is a flow diagram of a routine in the server system which processes an expedited payment package.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

In one embodiment, the payer logs into an online bill pay account in a server system, payer gets a unique identifier to the client system. The client system also retrieves payer-specific account information and a bill catalog from the server and displays them.

The server system sends the requested bill catalog information, for example via a webpage, to the client along with an indication of the single action to pay.

When a payer makes an expedited payment package, the payer selects the bills, sends the payment package with filled information and a request to pay. When single-action expedited pay is enabled, the payer need only perform a single action (such as a mouse button click) to pay all selected bills as a package. When the payer performs that single action, the client notifies the server with sufficient details. The server cancels previously defined date schedules and then schedules to complete the payments in a more timely fashion. Once the online bill catalog or an expedited package is displayed for a payer, the payer may only take a single action of request to pay. Since the client identifier identifies payer-specific account information which is stored in the server, it may not be necessary to transmit sensitive payer-specific information.

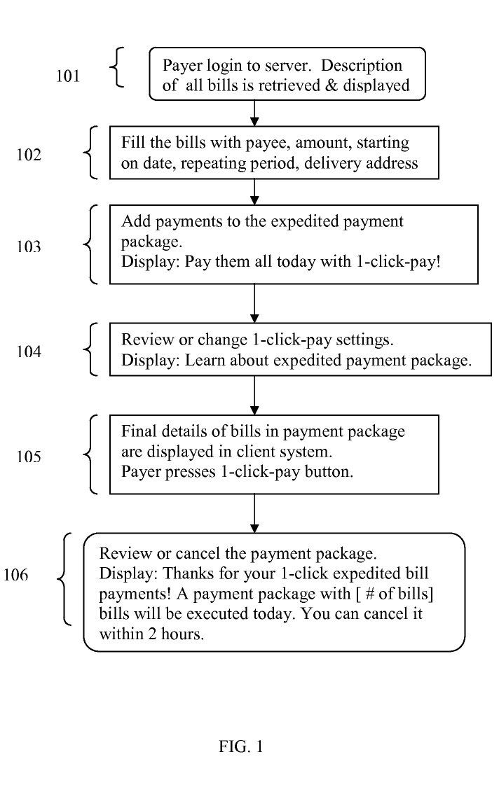

FIG. 1 illustrates single-action process for the grouped payments, viewing from the client system side. First, step 101, the user/payer logs into the online bill pay server from a client system. The client system retrieves the online catalog of all bills and their descriptions, and displays them on the screen.

At step 102, the user fills the bills with information such as payee, amount, starting on date, repeating period, delivery address by using either pre-stored information or manually inputs.

At step 103, user adds selected bills into an expedited payment package. The client system displays: pay them all today with 1-click.

At step 104, user reviews or changes the 1-click settings. The client system displays a link: Learn about expedited payment package. This link leads the user to a page for answers of the 1-click payment frequently asked questions.

At step 105, in the client system, the final details of the bills in expedited payment package are displayed. User clicks 1-click-pay button. At step 106, the user can review or cancel the payment package at this time. The client system displays a confirmation message, for example: “thanks for your 1-click expedited bill payments! A payment package with [#] of bills will be processed today. You may cancel it within 2 hours.”

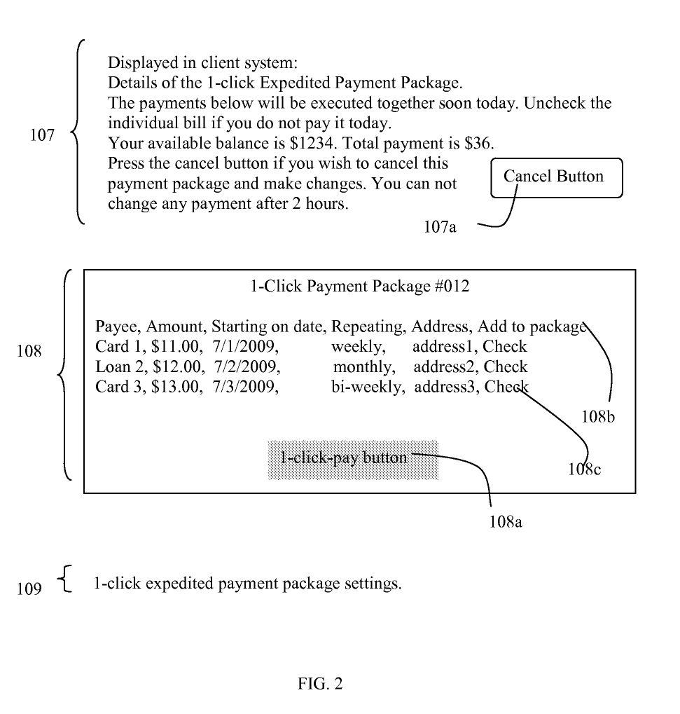

FIG. 2 illustrates a webpage in the client system describing a payment package and all bills in the user's online catalog. This webpage is sent from the server system, at a time when the payer logs into an online account, as well as when the payer wishes to get a confirmation page and to cancel or review detailed package information. This example page contains a summary description section 107, a package cancel button 107a, a bill section that describes the bills that may be paid and identifies which ones are in the package 108, a single-action pay button 108a, and a link to detailed description to 1-click section settings 109. These various sections may be rearranged or adapted in different ways. In general, the payer may need to check the bills 108c to be in the single action package 108b if it is not checked by default, and activate the single action 108a to make the request.

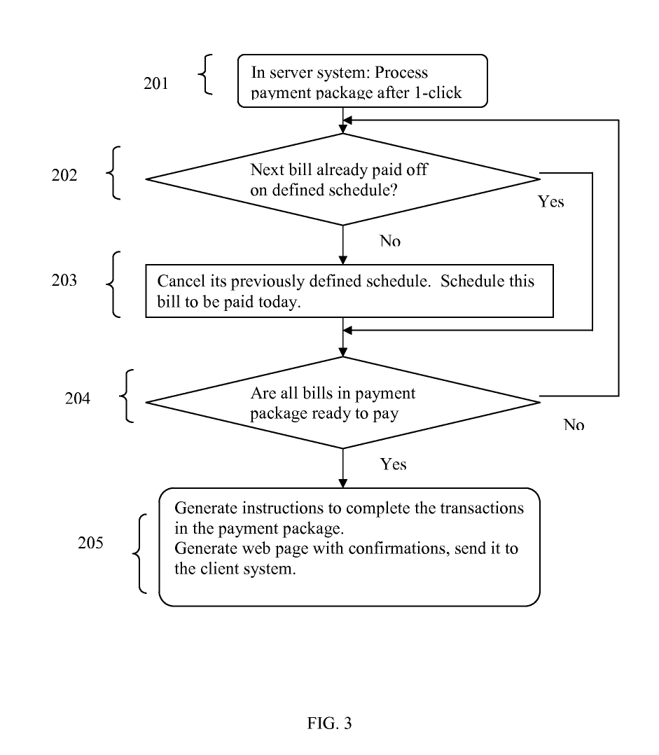

FIG. 3 illustrates the server system after it receives an expedited bill pay request. At step 201, the server system received the request and the payment package. It opens the payment package, and at step 202 checks every bill to be paid. It checks if this current bill is already paid today no matter what schedule it was defined. If yes, drops it and moves to next bill. If not, at step 203, the server cancels the current bill's previously defined schedule, and re-schedule it to be paid today according to its 1-click setting. At step 204, the server repeats above two steps till all bills in the package is with the same pay schedule. At step 205, in the final paying steps, the server will generate grouped paying instructions to effect the payments of the bill, and it finally generates the confirmation webpage and sends it back to the client system.

According to various embodiments, there is provided: an one-click method for executing a bill payment package through the Internet, comprising the actions of: defining a payment package on a user interface, including plurality of payees with an option of including plurality of payers; displaying said payment package with an option to modify said payment package by a user, and an one-click execution button; and in response to a single button click on said one-click execution button, executing said payment package all at once, overriding any previously defined individual schedules.

According to various embodiments, there is provided: a client system for executing a payment package, comprising: a browser displaying a payment package containing plurality of payees and; a predefined single-action instructing component that in response to performance of only a single action, sends a request to a server system, the request including an identifier of a payer and said payment package.

According to various embodiments, there is provided: a server system for executing a payment package, comprising: a receiving component for receiving a request for committing a payment package containing plurality of payees, a request including an identifier of one payer and the payment package; and a fulfillment component that completes plurality of transactions targeting said plurality of payees immediately according to the payment package setting.

### Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. An one-click method for executing a bill payment package through the Internet, comprising the actions of:
defining a payment package on a user interface, including plurality of payees with an option of including plurality of payers;
displaying said payment package with an option to modify said payment package by a user, and an one-click execution button; and
in response to a single button click on said one-click execution button, executing said payment package all at once, overriding any previously defined individual schedules.

2. The method of claim 1 wherein the user is not the payer.

3. The method of claim 1, wherein the user is identified with a user identifier.

4. The method of claim 1, further comprising the action of storing said payment package on a server system.

5. The method of claim 1, further comprising the action of storing the information in connection with the execution of the payment package.

6. The method of claim 1, wherein said payees are imported from multiple individual bill payments.

7. The method of claim 1, wherein said displaying shows an option to pay each individual payee separately and on a different time schedule.

8. The method of claim 1, wherein said defining action has an option to define plurality of payment packages.

9. The server system of claim 1, wherein the displaying includes displaying an HTML or XML or any type of web document provided by a server system.

10. A client system for executing a payment package, comprising:
a browser displaying a payment package containing plurality of payees and;
a predefined single-action instructing component that in response to performance of only a single action, sends a request to a server system, the request including an identifier of a payer and said payment package.

11. The client system of claim 10 wherein the predefined single-action is the one clicking of a mouse button, or one depressing of a key on a keyboard.

12. The client system of claim 10, wherein the single action feature can be enabled or disabled.

13. The client system of claim 10, wherein the single action feature specifies the date or time or frequencies of dates a payment package needs to be processed.

14. The client system of claim 10, wherein said request can be canceled within a pre-defined period of time.

15. A server system for executing a payment package, comprising:
a receiving component for receiving a request for committing a payment package containing plurality of payees, a request including an identifier of one user and the payment package; and
a fulfillment component that completes plurality of transactions targeting said plurality of payees immediately according to the payment package setting.

16. The server system of claim 15, wherein the request is sent by a client system in response to only a single action being performed.

17. The server system of claim 16, wherein the client system and server system communicate through the Internet.

18. The server system of claim 15, wherein the request has an identifier of at least one payer and at least one payment package.

19. The server system of claim 15, wherein said payment package is stored in the server system for inquires.

20. The sever system of claim 15, wherein sail fulfillment component checks to see if said plurality of transactions had been executed on that day, if said plurality of transactions had been performed, the component exits without performing and sends a reminder message.
